(19) United States
(12) Patent Application Publication
(10) Pub. No.: US 2015/0344664 A1
(43) Pub. Date: Dec. 3, 2015

(54) REINFORCED THERMOPLASTIC ARTICLES, COMPOSITIONS FOR THE MANUFACTURE OF THE ARTICLES, METHODS OF MANUFACTURE, AND ARTICLES FORMED THEREFROM

(71) Applicant: SABIC Global Technologies B.V., Bergen Op Zoom (NL)

(72) Inventors: Thomas Adjei, Dalton, MA (US); Benny Ezekiel David, Great Barrington, MA (US); Dennis Lockyer, Pittsfield, MA (US); Craig Milne, Mt. Vernon, IN (US); Erich Otto Teutsch, Mt. Vernon, IN (US)

(21) Appl. No.: 14/822,529

(22) Filed: Aug. 10, 2015

Related U.S. Application Data
(63) Continuation of application No. 13/232,577, filed on Sep. 14, 2011.

(51) Int. Cl. C08J 9/28; B32B 37/04; B32B 37/10; B32B 37/06; C08J 9/00; B32B 37/18

(52) U.S. Cl. CPC C08J 9/28; C08J 9/0061; C08J 9/0085; C08J 9/0066; B32B 37/182; B32B 37/10; B32B 37/06; B32B 37/04; C08J 2379/08; C08J 2469/00; B32B 2605/00

(57) ABSTRACT

A composition for the manufacture of a porous, compressible article, the composition comprising a combination of: a plurality of reinforcing fibers; a plurality of polyimide fibers; and a plurality of polymeric binder fibers; wherein the polymeric binder fibers have a melting point lower than the polyimide fibers; methods for forming the porous, compressible article; and articles containing the porous, compressible article. An article comprising a thermoformed dual matrix composite is also disclosed, wherein the composite exhibits a time to peak release, as measured by FAR 25.853 (OSU test), a 2 minute total heat release, as measured by FAR 25.853 (OSU test), and an NBS optical smoke density of less than 200 at 4 minutes, determined in accordance with ASTM E-662 (FAR/JAR 25.853).

### CROSS REFERENCE TO RELATED APPLICATION

The present application is a continuation of U.S. Nonprovisional application Ser. No. 13/232,577 filed Sep. 14, 2011, which is hereby incorporated by reference in its entirety.

### BACKGROUND OF THE INVENTION

This disclosure relates to reinforced thermoplastic articles, in particular fiber-reinforced polyimide articles that can be thermoformed, compositions for the manufacture of the thermoformable articles, and methods of manufacture, articles, and uses thereof.

Thermoplastic articles containing reinforcing fibers are being used to an increasing extent for the production of components employed in the interior of vehicles such as commercial aircraft, ships, and trains. It is desirable for such materials, particularly where they are used in aircraft, to have excellent flame retardant properties and to release only low levels of heat and smoke when exposed to a flame. According to the Federal Aviation Regulations (FAR), specific flame retardant properties of interest for panels used in the interior of aircraft include, at minimum, a low heat release rate (referred to as the OSU 65/65 standard), low smoke density, and low toxicity of combustion products. These are often referred to as the flame-smoke-toxicity (FST) requirements for the aircraft interior panels. Many materials can only meet these requirements by adding additional layers to the panels, which adds to material cost, labor cost, and weight. Providing aesthetic finishes to the observable surfaces can require additional manual labor. In addition to meeting FST requirements, materials useful in manufacture of thermoplastic articles containing reinforcing fibers generally also have good processability for forming the articles, and desirable physical properties such as attractive surface finishes, toughness to minimize the propensity of the parts to crack during use or secondary operations, weatherability, and transparency where desired.

There accordingly remains a continuing need in the art for materials useful in manufacture of reinforced thermoplastic thermoformed articles that have a low heat release rate and low smoke density. It is also desirable for such materials to have combustion products with low toxicity. In addition, it would be advantageous if manufacture of the reinforced thermoformable articles from which the thermoformed articles are made were efficient and economical. Yet a further advantage would be for thermoformed articles to have one or more of toughness, weatherability, and chemical resistance and ease of cleaning.

### SUMMARY OF THE INVENTION

The invention relates to a composition for the manufacture of a porous, compressible article, the composition comprising a combination of:

a plurality of reinforcing fibers;

a plurality of polyimide fibers; and

a plurality of polymeric binder fibers;

wherein the polymeric binder fibers have a melting point lower than the polyimide fibers.

In another embodiment, the invention relates to a method for forming a porous article, the method comprising:

forming a layer comprising a suspension of the composition of claim 1-3 in liquid;

at least partially removing the liquid from the suspension to form a web;

heating the web under conditions sufficient to remove any remaining liquid from the web and to melt the polymeric binder fibers but not the polyimide; and

cooling the heated web to form the porous mat, wherein the porous article comprises a network of the reinforcing fibers and the polyimide fibers in a matrix of the polymeric binder.

In another embodiment, the invention relates to a porous article comprising:

a network of a plurality of reinforcing fibers and a plurality of polyimide fibers; and

a matrix deposited on the network comprising melted and cooled polymeric binder fibers, wherein the polymeric binder has a melt temperature lower than the polyimide fibers.

In another embodiment, the invention relates to a method of forming a dual matrix composite, the method comprising:

heating and compressing at least one of the porous articles of claim 8-10 disposed on a carrier layer under conditions sufficient to melt the polyimide fibers and consolidate the network;

cooling the heated, compressed article and carrier layer under pressure to form the dual matrix composite comprising

a network comprising a plurality of reinforcing fibers; and

a matrix comprising melted and cooled polyimide fibers and melted and cooled polymeric binder fibers, wherein the polymeric binder has a melt temperature lower than the polyimide.

In another embodiment, the invention relates to a dual matrix, thermoformable composite, comprising:

a network comprising a plurality of reinforcing fibers; and

a matrix comprising melted and cooled polyimide fibers and melted and cooled polymeric binder fibers, wherein the polymeric binder has a melt temperature lower than the polyimide, and

wherein the dual matrix composite has a minimum degree of loft of greater than or equal to three.

In another embodiment, the invention relates to a method of forming an article, the method comprising: thermoforming the dual matrix composite to form the article.

In another embodiment, the invention relates to an article, comprising: a thermoformed dual matrix composite.

In another embodiment, the invention relates to a dual matrix composite, comprising:

a network comprising a plurality of reinforcing fibers selected from metal fibers, metallized inorganic fibers, metallized synthetic fibers, glass fibers, graphite fibers, carbon fibers, ceramic fibers, mineral fibers, basalt fibers, polymer fibers having a melt temperature at least 150° C. higher than the polyimide, and combinations thereof; and

a matrix comprising (a) melted and cooled polyimide fibers and (b) melted and cooled polymeric binder fibers, wherein the polymeric binder has a melt temperature lower than the polyimide, and

wherein the dual matrix composite has a minimum degree of loft of greater than or equal to three and the loft of the dual matrix composite is within 30% over the entirety of the dual matrix composite;

### DETAILED DESCRIPTION OF THE INVENTION

The inventors hereof have developed a reinforced thermoplastic thermoformable article, referred to herein as a “dual matrix composite,” which can be thermoformed into an article having a low heat release rate and low smoke density. In an embodiment, the combustion products of the thermoformable article have low toxicity. To manufacture the dual matrix composite, a porous mat is formed from a composition containing a combination of reinforcing fibers, polyimide fibers, and polymeric binder fibers. The polymeric binder fibers has a lower melting temperature than the polyimide fibers, allowing the porous mat to be formed by heating the combination of the three fibrous components at a temperature effective to melt the polymeric binder fibers, but not the polyimide fibers. The polymer binder forms a first matrix that provides strength to the mat once cooled. The porous mat is then consolidated by heating, under compression, to a temperature sufficient to melt the polyimide, form a second matrix, and thereby form the dual matrix composite. Use of the combination of the three fibrous components allows uniform mixing and distribution of the components in the porous mat, and can provide mats having thinner profiles. The selected polymers are also sufficiently stable to survive repeated heating to processing or forming temperature with minimal oxidation. The properties and composition of the porous mat can be varied according to need, for example, by varying the type, dimensions, and amount of reinforcing fiber and polymeric binder. Importantly, the polymeric binder does not degrade the FST properties of the final thermoformed products, and the final thermoformed product meets all of the required FST properties without requiring any additional layers or additives.

The dual matrix composites formed from the porous mats have a degree of loft of 3 or more, with excellent uniformity across the thickness of the mat. The dual matrix composites can be thermoformed, for example, to provide an article. The dual matrix composite can thus be used in the manufacture of components that meet the FAR requirements for low heat, low smoke density, and/or low levels of toxic combustion by-products. In an embodiment, the dual matrix composite satisfies the following criteria: (1) a peak heat release of less than 65 kW/m², as measured by FAR 25.853 (OSU test); (2) a total heat release at 2 minutes of less than or equal to 65 kW*min/m² as measured by FAR 25.853 (OSU test); and an NBS optical smoke density of less than 200 when measured at 4 minutes, based on ASTM E-662 (FAR/JAR 25.853).

The singular forms “a,” “an,” and “the” include plural referents unless the context clearly dictates otherwise. The endpoints of all ranges reciting the same characteristic or component are independently combinable and inclusive of the recited endpoint. The term “combination” is inclusive of blends, mixtures, alloys, reaction products, and the like. The term “and a combination thereof” is inclusive of the named component and/or other components not specifically named that have essentially the same function.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The term “from more than 0 to” an amount means that the named component is present in some amount more than 0, and up to and including the higher named amount.

“Melt temperature” as used herein refers to the melt temperature of crystalline polymers, or the glass transition or softening temperature of amorphous polymers.

Compounds are described herein using standard nomenclature. A dash (“-”) that is not between two letters or symbols is used to indicate a point of attachment for a substituent. For example, —CHO is attached through the carbon of the carbonyl (C═0) group. As used herein, the term “alkyl” refers to a straight or branched chain monovalent hydrocarbon group; “alkylene” refers to a straight or branched chain divalent hydrocarbon group; “alkylidene” refers to a straight or branched chain divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicyclic hydrocarbon group having at least three carbon atoms, “cycloalkylene” refers to a non-aromatic alicyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to a an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that any at least one hydrogen on the designated atom or group is replaced with another group, provided that the designated atom's normal valence is not exceeded. When the substituent is oxo (i.e., ═0), then two hydrogens on the atom are replaced. Combinations of substituents and/or variables are permissible provided that the substitutions do not significantly adversely affect synthesis or use of the compound.

As described above, a composition having three different types of fibers is used to form a porous mat, which in turn is consolidated to provide the dual matrix composite. The compositions for forming the porous mat include a plurality of reinforcing fibers; a plurality of polyimide fibers; and a plurality of polymeric binder fibers, wherein the polymeric binder fibers have a melting point lower than the polyimide fibers.

The reinforcing fibers can be metal fibers (e.g., stainless steel fibers), metallized inorganic fibers, metallized synthetic fibers, glass fibers (e.g., lime-aluminum borosilicate glass that is soda-free (“E” glass), A, C, ECR, R, S, D, or NE glasses), graphite fibers, carbon fibers, ceramic fibers, mineral fibers, basalt fibers, polymer fibers having a melt temperature at least 150° C. higher than the polyimide, or a combination thereof. The reinforcing fibers generally have a modulus higher than 10 GigaPascals (GPa). In an embodiment, the reinforcing fibers are glass fibers, a compatible non-glass material, or a combination thereof. As used herein, the term “compatible non-glass material” refers to a non-glass material having at least surface adhesion and wetting properties similar to those of glass, which will allow for uniform dispersion with the glass fibers.

The reinforcing fibers can be provided in the form of monofilament or multifilament fibers; non-woven fibrous reinforcements such as continuous strand mat, chopped strand mat, tissues, papers, and felts or the like. In an embodiment, the reinforcing fibers are discontinuous, in the form of single discrete fibers. Where glass fibers are used and are received in the form of chopped strand bundles, the bundles can be broken down into single fibers before the structure is formed. The discontinuous reinforcing fibers can be 5 to 75 millimeters (mm) in the longest dimension, specifically 6 to 60 mm, more specifically 7 to 50 mm, and still more specifically 10 to 40 mm in the longest dimension. In addition, the discontinuous reinforcing fibers can be 5 to 125 micrometers (μm), specifically 10 to 100 micrometers.

The polyimide fibers contribute one type of polymer to the dual polymer matrix. A wide variety of polyimides can be used, depending on the availability, melt temperature, and desired characteristics of the dual matrix composites. As used herein, “polyimides” is inclusive of polyetherimides and polyetherimide sulfones. In a specific embodiment, the polyetherimide comprise more than 1, specifically 10 to 1,000, or more specifically, 10 to 500 structural units, of formula (1)

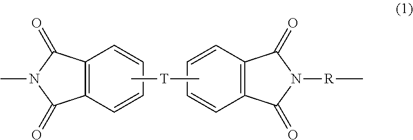

wherein T is —O— or a group of the formula —O—Z—O— wherein the divalent bonds of the —O— or the —O—Z—O— group are in the 3,3′, 3,4′, 4,3′, or the 4,4′ positions and Z is a divalent group that includes, but is not limited to, divalent moieties of formulas (2)

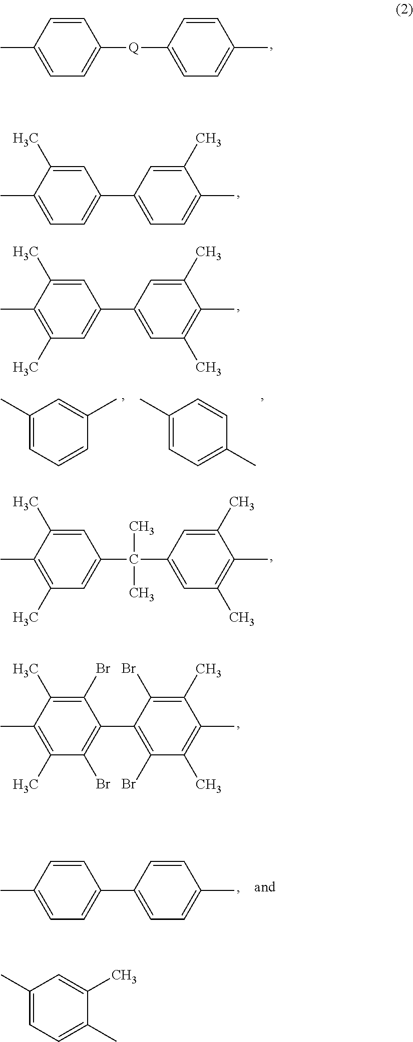

wherein Q is a divalent moiety comprising —O—, —S—, —C(O)—, —SO₂—, —SO—, —C_{y}H_{2y}— and halogenated derivatives thereof, including perfluoroalkylene groups as defined above, y being an integer from 1 to 20; and wherein R is a divalent group of formula (3)

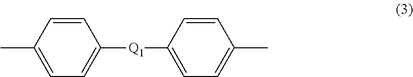

wherein Q is a divalent moiety such as —O—, —S—, —C(O)—, —SO₂—, —SO—, —C_{y}H_{2y}— and halogenated derivatives thereof, including perfluoroalkylene groups, y being an integer from 1 to 5.

In another specific embodiment, the polyetherimide sulfones can comprise more than 1, specifically 10 to 1,000, or more specifically, 10 to 500 structural units of formula (4)

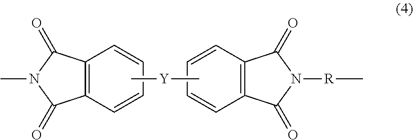

wherein Y is —O—, —SO₂—, or a group of the formula —O—Z—O— wherein the divalent bonds of the —O—, SO₂—, or the —O—Z—O— group are in the 3,3′, 3,4′, 4,3′, or the 4,4′ positions, wherein Z is a divalent group of formula (2) as defined above and R is a divalent group of formula (3) as defined above, provided that greater than 50 mole % of the sum of moles Y+moles R in formula (1) contain —SO₂— groups.

The polyetherimide and polyetherimide sulfones can be prepared by various methods, including, but not limited to, the reaction of an aromatic bisanhydride of the formula (5) or (6)

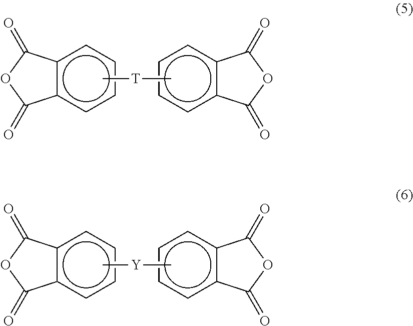

with an organic diamine of the formula (7)

H₂N—R—NH₂ (7)

wherein R, T, and Y are as defined above.

Illustrative examples of specific aromatic bisanhydrides of formula (5) include: 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; and 4-(2,3-dicarboxyphenoxy)-4′-(3,4-dicarboxyphenoxy)benzophenone dianhydride. Combinations comprising at least one of the foregoing can be used.

Illustrative examples of specific aromatic bisanhydrides containing sulfone groups of formula (6) include: 4,4′-bis(3,4-dicarboxyphenoxy)diphenyl sulfone dianhydride; 4,4′-bis(2,3-dicarboxyphenoxy)diphenyl sulfone dianhydride; and 4-(2,3-dicarboxyphenoxy)-4′-(3,4-dicarboxyphenoxy)diphenyl sulfone dianhydride. Combinations comprising at least one of the foregoing can be used. In addition, the polyetherimide sulfones can be prepared using a combination of bisanhydrides of formula (5) and formula (6).

Illustrative examples of amine compounds of formula (7) include: ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl)benzene, bis(p-b-methyl-o-aminopentyl)benzene, 1,3-diamino-4-isopropylbenzene, bis(4-aminophenyl) ether and 1,3-bis(3-aminopropyl)tetramethyldisiloxane. Mixtures of these amines can be used.

Illustrative examples of amine compounds of formula (7) containing sulfone groups include but are not limited to, diamino diphenyl sulfone (DDS) and bis(aminophenoxy phenyl) sulfones (BAPS). Combinations comprising any of the foregoing amines can be used.

In an embodiment, the polyetherimide comprises structural units of formula (1) wherein each R is independently p-phenylene or m-phenylene or a mixture comprising at least one of the foregoing; and T is group of the formula —O—Z—O— wherein the divalent bonds of the —O—Z—O— group are in the 3,3′ positions, and Z is a divalent group of formula(8)

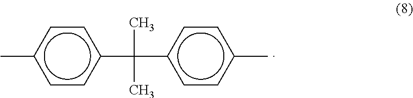

The polyetherimides and polyetherimide sulfones have a weight average molecular weight (Mw) of 5,000 to 80,000 Daltons. Weight average molecular weight can be measured by gel permeation chromatography, using a polystyrene standard. Representative polyetherimides are those produced under the ULTEM® trademark, including, but not limited to ULTEM® 1000 (number average molecular weight (Mn) 21,000 g/mole; Mw 54,000 g/mole; dispersity 2.5), ULTEM® 1010 (Mn 19,000 g/mole; Mw 47,000 g/mole; dispersity 2.5) and ULTEM 9011 (Mn 19,000 g/mole; Mw 47,000 g/mole; dispersity 2.5) resin by Sabic Innovative Materials, Pittsfield, Mass.

The polyimide fibers can be 5 to 75 millimeters (mm) in the longest dimension, specifically 6 to 60 mm, more specifically 7 to 50 mm, and still more specifically 10 to 40 mm in the longest dimension. In addition, the discontinuous reinforcing fibers can be 5 to 125 micrometers (μm), specifically 10 to 100 micrometers.

The polymer binder fibers contribute another polymer to the dual polymer matrix. The polymer binder melts during formation of the porous mat, and is therefore selected to have a melt temperature lower than the melt temperature of the polyetherimide. For example, the polymer binder can have a melt temperature that is at least 10° C. lower than the melt temperature of the polyimide, specifically at least 20° C. lower, even more specifically at least 20° C. lower than the melt temperature of the polyimide. The polymer binder is further selected so as to be compatible with the polyimide and the reinforcing fibers. The polymer binder further preferably is selected so as to not contribute significantly to the heat release, optical smoke density, and/or combustion products toxicity of the dual matrix composites. Possible polymer binders that can meet these criteria include thermoplastic polyolefin blends, polyvinyl polymers, butadiene polymers, acrylic polymers, silicone polymers, polyamides, polyesters, polycarbonates, polyestercarbonates, polystyrenes, polysulfones, polyarylsulfones, polyphenylene ethers polyphenylene-sulphide, polyethers, polyetherketones, and polyethersulfones, or a combination thereof. In an embodiment, the polymer binder is a polysiloxane-polyestercarbonate copolymer, polyester, polyester-polyetherimide blend, bicomponent fiber of any of the foregoing, or a combination thereof.

The polysiloxane-polyestercarbonate copolymer comprises siloxane units and arylate ester units that can comprise aromatic carbonate units.

The siloxane units are present in the copolymer in polysiloxane blocks, which comprise repeating siloxane units as in formula (10)

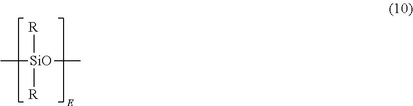

wherein each R is independently the same or different C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

The value of E in formula (10) can vary depending on the type and relative amount of each component in the composition, the desired properties of the, and like considerations. Generally, E has an average value of 5 to 50, specifically 5 to about 40, more specifically 10 to 30. In one embodiment, the polysiloxane blocks are of formula (11) or (12)

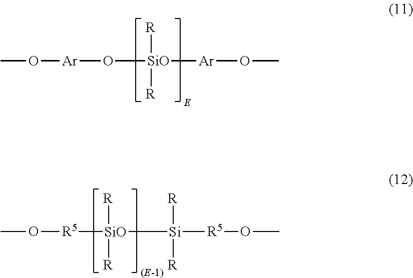

wherein E is as defined above and each R can be the same or different, and is as defined above. Ar can be the same or different, and is a substituted or unsubstituted C₆-C₃₀ arylene group, wherein the bonds are directly connected to an aromatic moiety. Ar groups in formula (11) can be derived from a C₆-C₃₀ dihydroxyarylene compound of formula (14) below, for example 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane. Combinations comprising at least one of the foregoing compounds can also be used. Each R⁵ is independently a divalent C₁-C₃₀ organic group, for example a divalent C₂-C₈ aliphatic group.

In a specific embodiment, the polysiloxane blocks are of formula (13):

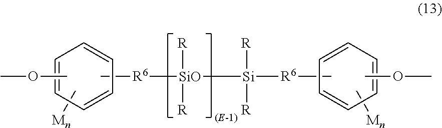

wherein R and E are as defined above; R⁶ is a divalent C₂-C₈ aliphatic group; each M can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4. In an embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R² is a divalent C₁-C₃ aliphatic group, and R is methyl.

The polysiloxane-polyestercarbonate copolymer further comprises polyester blocks, in particular polyarylate ester blocks that optionally comprise carbonate units. The arylate ester units of the polyarylate ester blocks can be derived from the reaction product of one equivalent of an isophthalic acid derivative and/or terephthalic acid derivative with an aromatic dihydroxy compound of the formula HO—R¹—OH, in particular of formula (14) or (15):

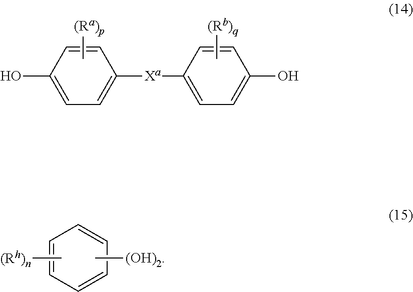

In formula (14), R^{a} and R^{b} each independently a halogen atom or a monovalent hydrocarbon group; p and q are each independently integers of 0 to 4; and X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is —C(R^{c})(R^{d})— or —C(═R^{e}) (wherein R^{c} and R^{d} each independently is a hydrogen atom or a monovalent linear or cyclic hydrocarbon group and R^{e} is a divalent hydrocarbon group), a single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ alkyl group, specifically methyl, disposed meta to the hydroxy group on each arylene group. In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

In formula (15), wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (14) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Specific examples of compounds of formula (15) include 5-methyl resorcinol, hydroquinone, and 2-methyl hydroquinone. Combinations comprising at least one of the foregoing dihydroxy compounds can also be used.

The polyarylate ester blocks can comprise 100 mole % (mol %) of arylate ester units as illustrated in formula (16):

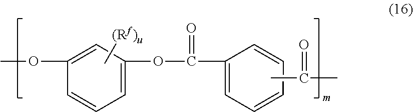

wherein R^{f} and u are previously defined for formula (15), and m is greater than or equal to 4. In an embodiment, m is 4 to 50, specifically 5 to 30, more specifically 5 to 25, and still more specifically 10 to 20. Also in an embodiment, m is less than or equal to 100, specifically less than or equal to 90, more specifically less than or equal to 70, and still more specifically less than or equal to 50. It will be understood that the low and high endpoint values for m are independently combinable. In another embodiment, the molar ratio of isophthalate to terephthalate can be about 0.25:1 to about 4.0:1.

Exemplary arylate ester units are aromatic polyester units such as isophthalate-terephthalate-resorcinol ester units, isophthalate-terephthalate-bisphenol A ester units, or a combination thereof. Specific arylate ester units include poly(isophthalate-terephthalate-resorcinol) esters, poly(isophthalate-terephthalate-bisphenol-A) esters, poly[(isophthalate-terephthalate-resorcinol) ester-co-(isophthalate-terephthalate-bisphenol-A)] ester, or a combination thereof. In an embodiment, a useful arylate ester unit is a poly(isophthalate-terephthalate-resorcinol) ester. In an embodiment, the arylate ester unit comprises isophthalate-terephthalate-resorcinol ester units in an amount greater than or equal to 95 mol %, specifically greater than or equal to 99 mol %, and still more specifically greater than or equal to 99.5 mol % based on the total number of moles of ester units in the polyarylate unit. In another embodiment, the arylate ester units are not substituted with non-aromatic hydrocarbon-containing substituents such as, for example, alkyl, alkoxy, or alkylene substituents.

Alternatively, the polyarylate ester blocks are polyestercarbonate blocks that comprise arylate ester units and carbonate units shown in formula (17):

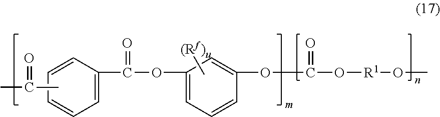

wherein R^{f}, u, and m are as defined in formula (16), each R¹ is independently an aromatic dihydroxy compound of the formula HO—R¹—OH, in particular of formula (14) or (15), and n is greater than or equal to one. In an embodiment, m is from 3 to 50, specifically from 5 to 25, and more specifically from 5 to 20; and n is less than or equal to 50, specifically less than or equal to 25, and more specifically less than or equal to 20. It will be understood that the endpoint values for n are independently combinable. In an embodiment, m is from 5 to 75, specifically from 5 to 30, and more specifically from 10 to 25, and n is less than 20. In a specific embodiment, m is 5 to 75, and n is 3 to 50; or m is 10 to 25, and n is 5 to 20. In an embodiment, the molar ratio of the isophthalate-terephthalate ester units to the carbonate units in the polyestercarbonate block can be 100:0 to 50:50, specifically 95:5 to 60:40, more specifically 90:10 to 70:30.

In a specific embodiment, the polyestercarbonate unit comprises bisphenol carbonate units of formula (18) (derived from bisphenols of formula (14) and/or resorcinol carbonate units of formula (19) (derived from resorcinols of formula (15):

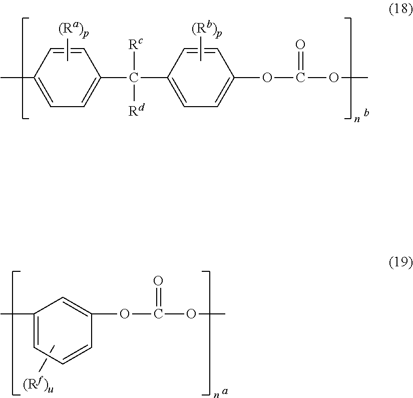

wherein R^{a} and R^{b} are each individually C₁₋₈ alkyl, R^{c} and R^{d} are individually C₁₋₈ alkyl or C₁₋₈ cycloalkylene, p and q are 0 to 4, and n^{b} is greater than or equal to one; and wherein R^{f} and u are as described above, and n^{a} is greater than or equal to 1. The polyestercarbonate units comprise a molar ratio of bisphenol carbonate units of formula (18) to resorcinol carbonate units of formula (19) of 0:100 to 99:1, specifically 20:80 to 80:20. In a specific embodiment, the polyestercarbonate blocks are derived from resorcinol (i.e., 1,3-dihydroxybenzene), or a combination comprising resorcinol and bisphenol-A, and more specifically, the polyestercarbonate block is a poly(isophthalate-terephthalate-resorcinol ester)-co-(resorcinol carbonate)-co-(bisphenol-A carbonate).

In an embodiment, the polyestercarbonate blocks of the polysiloxane-polyestercarbonate copolymer consist of 50 to 100 mol % of arylate ester units, specifically 58 to 90 mol % arylate ester units; 0 to 50 mol % aromatic carbonate units (e.g., resorcinol carbonate units, bisphenol carbonate units and other carbonate units such as aliphatic carbonate units); 0 to 30 mol % resorcinol carbonate units, specifically 5 to 20 mol % resorcinol carbonate units; and 0 to 35 mol % bisphenol carbonate units, specifically 5 to 35 mol % bisphenol carbonate units.

The polyestercarbonate unit can have an M_{w} of 2,000 to 100,000 g/mol, specifically 3,000 to 75,000 g/mol, more specifically 4,000 to 50,000 g/mol, more specifically 5,000 to 35,000 g/mol, and still more specifically 17,000 to 30,000 g/mol. Molecular weight determinations are performed using GPC using a crosslinked styrene-divinyl benzene column, at a sample concentration of 1 milligram per milliliter, and as calibrated with polycarbonate standards. Samples are eluted at a flow rate of about 1.0 ml/min with methylene chloride as the eluent.

The polysiloxane-polyestercarbonate copolymers can be manufactured by methods known in the art, for example reaction of the corresponding dihydroxy compounds of formulas (11), (12), and (13) with dicarboxylic acid derivatives and dihydroxy compounds of formulas (14) and (15) by different methods such as solution polymerization, interfacial polymerization, and melt polymerization. For example, the polysiloxane-polyestercarbonate copolymer can be prepared by interfacial polymerization, such as by the reaction of a diacid derivative, a difunctional polysiloxane polymer, a dihydroxy aromatic compound, and where desired, a carbonyl source, in a biphasic medium comprising an immiscible organic phase and aqueous phase. The order and timing of addition of these components to the polymerization reaction can be varied to provide a polysiloxane-polyestercarbonate copolymer having different distributions of the polysiloxane blocks in the polymer backbone. The polysiloxane can be distributed within the ester units in the polyester units, the carbonate units in the polycarbonate units, or both. Proportions, types, and amounts of the reaction ingredients can be selected by one skilled in the art to provide polysiloxane-polyestercarbonate copolymers having specific desirable physical properties for example, heat release rate, low smoke, low toxicity, haze, transparency, molecular weight, polydispersity, glass transition temperature, impact properties, ductility, melt flow rate, and weatherability.

In an embodiment, the polysiloxane-polyestercarbonate copolymer can comprise siloxane units in an amount of 0.5 to 20 mol %, specifically 1 to 10 mol % siloxane units, based on the combined mole percentages of siloxane units, arylate ester units, and optional carbonate units, and provided that siloxane units are provided by polysiloxane units covalently bonded in the polymer backbone of the polysiloxane-polyestercarbonate copolymer composition. The polysiloxane-polyestercarbonate copolymer comprises siloxane units in an amount of 0.2 to 10 weight percent (wt %), specifically 0.2 to 6 wt %, more specifically 0.2 to 5 wt %, and still more specifically 0.25 to 2 wt %, based on the total weight of the polysiloxane-polyestercarbonate copolymer, with the proviso that the siloxane units are provided by polysiloxane units covalently bonded in the polymer backbone of the polysiloxane-polyestercarbonate copolymer. In another embodiment, the copolymer further comprises 0.2 to 10 wt % siloxane units, 50 to 99.8 wt % ester units, and 0 or more than 0 to 49.85 wt % carbonate units; or 0.3 to 3 wt % polysiloxane units, 60 to 96.7 wt % ester units, and 3 to 40 wt % carbonate units, wherein the combined weight percentages of the polysiloxane units, ester units, and carbonate units is 100 wt % of the total weight of the polysiloxane-polyestercarbonate copolymer composition.

The polysiloxane-polyestercarbonate copolymers can have an intrinsic viscosity, as determined in chloroform at 25° C., of 0.3 to 1.5 deciliters per gram (dl/g), specifically 0.45 to 1.0 dl/g. The polysiloxane-polyestercarbonate copolymers can have a weight average molecular weight (M_{w}) of 10,000 to 100,000 g/mol, as measured by gel permeation chromatography (GPC) using a crosslinked styrene-divinyl benzene column, at a sample concentration of 1 milligram per milliliter, and as calibrated with polycarbonate standards.

In an embodiment, the polysiloxane-polyestercarbonate copolymer has flow properties described by the melt volume flow rate (MVR), which measures the rate of extrusion of a thermoplastic polymer through an orifice at a prescribed temperature and load. Polysiloxane-polyestercarbonate copolymers suitable for use can have an MVR, measured at 300° C. under a load of 1.2 kg according to ASTM D1238-04, of 0.5 to 80 cubic centimeters per 10 minutes (cc/10 min). In a specific embodiment, an exemplary polycarbonate has an MVR measured at 300° C. under a load of 1.2 kg according to ASTM D1238-04, of 0.5 to 100 cc/10 min, specifically 1 to 75 cc/10 min, and more specifically 1 to 50 cc/10 min. Combinations of polycarbonates of different flow properties can be used to achieve the overall desired flow property. The polysiloxane-polyestercarbonate copolymer can have a T_{g} of less than or equal to 165° C., specifically less than or equal to 160° C., and more specifically less than or equal to 155° C. The polysiloxane-polyestercarbonate copolymer can have a T_{g} for the polycarbonate unit of greater than or equal to 115° C., specifically greater than or equal to 120° C. In an embodiment, the polysiloxane-polyestercarbonate copolymer has a melt volume rate (MVR) of 1 to 30 cc/10 min, specifically 1 to 20 cc/10 min., when measured at 300° C. under a load of 1.2 kg according to ASTM D1238-04, and a T_{g} of 120 to 160° C., specifically 125 to 155° C., and still more specifically 130 to 150° C.

Still further in an embodiment, the polysiloxane-polyestercarbonate copolymer composition has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853 (d). Polysiloxane-polyestercarbonate copolymers are commercially available from SABIC Innovative Plastics, Pittsfield, Mass.

Prior to being formed into fibers, the polyimides and/or binder polymers can be formulated with various additives ordinarily incorporated into polymer compositions of this type, with the proviso that the additives are selected so as to not significantly adversely affect the desired properties of the fibers. Exemplary additives include fillers, catalysts (for example, to facilitate reaction between an impact modifier and the polyester), antioxidants, thermal stabilizers, light stabilizers, ultraviolet light (UV) absorbing additives, quenchers, plasticizers, lubricants, mold release agents, antistatic agents, visual effect additives such as dyes, pigments, and light effect additives, flame resistances, anti-drip agents, and radiation stabilizers. Combinations of additives can be used. The foregoing additives (except any fillers) are generally present in an amount from 0.005 to 20 wt. %, specifically 0.01 to 10 wt. %, based on the total weight of the composition.

In a specific embodiment, certain flame retarding agents are excluded from the compositions, in particular flame retardants that include phosphorus, bromine, and/or chlorine. Non-brominated and non-chlorinated phosphorus-containing flame retardants can be preferred in certain applications for regulatory reasons, for example organic phosphates. In another specific embodiment, inorganic flame retardants are excluded from the compositions, for example salts of C₁₋₁₆ alkyl sulfonate salts such as potassium perfluorobutane sulfonate (Rimar salt), potassium perfluorooctane sulfonate, tetraethyl ammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complexes such as Li₃AlF₆, BaSiF₆, KBF₄, K₃AlF₆, KAlF₄, K₂SiF₆, and/or Na₃AlF₆ or the like.

The polyimide and polymer binder are formed into fibers by means known in the art. These fibers, together with the reinforcing fibers are combined to provide a composition for the production of a porous article such as a mat. Consolidation of the porous article under heat and pressure provides a dual matrix composite that can then be thermoformed to provide articles useful in the manufacture of interior aircraft panels, for example.

In particular, a composition for the manufacture of a porous, compressible article such as a mat includes a combination of a plurality of reinforcing fibers; a plurality of polyimide fibers; and a plurality of polymeric binder fibers wherein the polymeric binder fibers have a melting point lower than the polyimide fibers. The composition is thermally treated to selectively melt and flow the polymer binder fibers such that the polymer binder adheres adjoining fibers together upon cooling, to produce a mat containing a network of discontinuous, randomly oriented reinforcing fibers and polyimide fibers bonded together using melted fibers of the polymer binder. The porous mat is then thermally treated under pressure to melt and flow the polyimide fibers such that the thermoplastic composition adheres adjoining fibers together upon cooling. In this way, an interconnected network of reinforcing fibers and a dual polymer matrix (polymer binder and polyimide) is formed. The network so prepared has high loft and uniformity across the structure.

A method for forming a porous mat according includes forming a layer comprising a suspension of the combination of a plurality of reinforcing fibers; a plurality of polyimide fibers; and a plurality of polymeric binder fibers in a liquid, for example an aqueous solvent; at least partially removing the liquid from the suspension to form a web; heating the web under conditions sufficient to remove any remaining aqueous solvent from the web and to melt the polymeric binder fibers but not the polyimide; and cooling the heated web to form the porous mat, wherein the porous mat comprises a network of the reinforcing fibers and the polyimide fibers in a matrix of the polymeric binder.

The reinforcing fibers, polyimide fibers, and polymeric binder fibers combined in a liquid medium to form a suspension, wherein the fibers are substantially uniformly suspended and distributed throughout the medium. In one embodiment, the combining is performed by introducing the fibers into an aqueous medium to provide a suspension, which can be a slurry, dispersion, foam, or emulsion. The combining is performed so as to render the fibers substantially evenly dispersed in the aqueous medium, and can use agitation to establish and maintain the dispersion of these components. The suspension can further comprise additives such as dispersants, buffers, anti-coagulants, surfactants, and the like, and combinations thereof, to adjust or improve the flow, dispersion, adhesion, or other properties of the suspension. Specifically, the suspension can be a foamed suspension comprising the fibers, water, and a surfactant. The percentage by weight of solids (wt. %) of the suspension can be from 1 to 99 wt %, specifically 2 to 50 wt %. Additives can be present in an amount effective for imparting desired properties of foaming, suspension, flow, and the like.

The suspension can be prepared in batch mode, and used directly or stored for later use, or alternatively be formed in a continuous manufacturing process wherein the components are each combined to form the suspension at a time just prior to the use of the suspension.

To form a porous article such as a mat, the suspension is applied as a slurry to a porous surface, for example a wire mesh, and the liquid and suspended components too small to remain on the porous surface are removed through the porous surface by gravity or use of vacuum, to leave a layer comprising a dispersion of fibers on the porous surface. In an exemplary embodiment, the porous surface is a conveyor belt having pores, and of dimensions suitable to provide, after application of the dispersed medium and removal of liquid, a fibrous mat having a width of 2 meters and of continuous length. The dispersed medium can be contacted to the porous surface by distribution through a head box, which provides for application of a coating of the dispersed medium having a substantially uniform width and thickness over the porous surface. Typically, vacuum is applied to the porous surface on a side opposite the side to which the dispersed medium is applied, to draw the residual liquid and/or small particles through the porous surface, thereby providing a web in substantially dried form. In an embodiment, the layer is dried to remove moisture by passing heated air through the layer mat.

Upon removal of the excess dispersed medium and/or moisture, the non-bonded, web comprising the fibers is thermally treated to form a porous article, for example a mat. In an embodiment, the web is heated by passing heated air through the web in a furnace. In this way, the web can be dried using air heated at a temperature of greater than or equal to, e.g., 100° C. under a flow of air. The heating temperature is selected to substantially soften and melt the polymer binder, but not the polyimide, for example at a temperature from 130 to 170° C. In an embodiment, the heating comprises heating in an oven at a temperature from 130 to 150° C., then infrared heating at a temperature from 150 to 170° C. During heating of the web, the polymer binder melts and flows to form a common contact (e.g., a bridge) between two or more of the reinforcing and polyimide fibers, and forms an adhesive bond with the fibers upon cooling to a non-flowing state, thereby forming the porous article.

The porous article comprises a network of the plurality of reinforcing fibers and the plurality of polyimide fibers; and a matrix deposited on the network comprising melted and cooled polymeric binder fibers, wherein the polymeric binder has a melt temperature lower than the polyimide fibers. The porous article can have an areal weight of from 90 to 500 g/m². Alternatively, or in addition, the porous article has a porosity of greater than about 0%, more particularly about 5% to about 95%, and still more particularly about 20% to about 80% by volume

A dual matrix composite is formed from the porous article, by heating and compressing at least one of the porous articles disposed on a carrier layer under conditions sufficient to melt the polyimide fibers and consolidate the network; and cooling the heated, compressed article and carrier layer under pressure to form the dual matrix composite comprising a network comprising a plurality of reinforcing fibers; and a matrix comprising melted and cooled polyimide fibers and melted and cooled polymeric binder fibers, wherein the polymeric binder has a melt temperature lower than the polyimide.

Heating is at a temperature effective to soften the polyimide, for example a temperature of 300 to 385° C., specifically 330 to 365° C., and a pressure of 5 to 25 bar, specifically 8 to 15 bar. During heating of the porous article, the polyimide softens and may flow to form a common contact (e.g., a bridge) between two or more of the reinforcing fibers, and forms an adhesive bond with the fibers upon cooling to a non-flowing state, thereby forming the dual matrix composite. Heat-treating and compression can be by a variety of methods, for example using calendaring rolls, double belt laminators, indexing presses, multiple daylight presses, autoclaves, and other such devices used for lamination and consolidation of sheets so that the polyimide can flow and wet out the fibers. The gap between the consolidating elements in the consolidation devices may be set to a dimension less than that of the unconsolidated web and greater than that of the web if it were to be fully consolidated, thus allowing the web to expand and remain substantially permeable after passing through the rollers. In one embodiment, the gap is set to a dimension about 5% to about 10% greater than that of the web if it were to be fully consolidated. It may also be set to provide a fully consolidated web that is later re-lofted and molded to form particular articles or materials. A fully consolidated web means a web that is fully compressed and substantially void free. A fully consolidated web would have less than about 5% void content and have negligible open cell structure.

In an embodiment, the article is a mat. Two or more mats can be stacked and heated treated under compression, specifically 2 to 8 mats.

In an advantageous feature, the dual matrix composite has a minimum degree of loft of greater than or equal to three. In another advantageous feature, the loft of the dual matrix composite is within one sigma, over the entirety of the dual matrix composite. Alternatively, or in addition, the loft of the dual matrix composite is within 30%, over the entirety of the dual matrix composite. Loft can be understood as the expansion that the dual matrix composite sheet undergoes as it is reheated without pressure above the melt temperature of the polyetherimide, compared to the thickness of the fully consolidated sheet. It indicates the degree of glass fiber attrition that occurred during consolidation, which provides an indication of mechanical strength and formability. Manufacturing cycle time of the dual matrix composites is shortened considerably, from several hours down to minutes.

The porosity of the dual matrix composite is generally less than about 10 volume % or is less than about 4 volume % of the porosity of the porous article, specifically less than about 3 volume %, more specifically less than about 2 volume %.

In a specific embodiment, a dual matrix composite includes a network comprising a plurality of reinforcing fibers selected from metal fibers, metallized inorganic fibers, metallized synthetic fibers, glass fibers, graphite fibers, carbon fibers, ceramic fibers, mineral fibers, basalt fibers, polymer fibers having a melt temperature at least 150° C. higher than the polyimide, and combinations thereof; and a matrix comprising (a) melted and cooled polyimide fibers and (b) melted and cooled polymeric binder fibers, wherein the polymeric binder has a melt temperature lower than the polyimide, and wherein the dual matrix composite has a minimum degree of loft of greater than or equal to three and the loft of the dual matrix composite is within 30% over the entirety of the dual matrix composite. In an embodiment, the dual matrix composite does not include a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

Layers of thermoplastic material, woven and non-woven fabrics, and the like, can optionally be laminated to the dual matrix composite to form a structure having two or more layers. Lamination is effected by feeding one or more optional top layers of material, and/or one or more bottom layers of material, such as for example a scrim layer, into a nip roller simultaneously with the dual matrix composite. The nip roller, which can be cooled by circulation of water through the rollers, can provide temperature control for the heated structure during application of pressure, and thus during formation of the composite. The roller pressure for compressing and/or compacting the fibrous mat and/or additional layers can be adjusted to maximize the final properties of the structure. In this way, layers such as adhesion layers, barrier layers, scrim layers, reinforcement layers, and the like, or a combination comprising at least one of the foregoing layers, can be applied to the core material. The layers can be continuous sheets, films, woven fabric, nonwoven fabric, and the like, or a combination comprising at least one of the foregoing. Materials useful for the layers include polyolefins such as polyethylene, polypropylene, poly(ethylene-propylene), polybutylene, adhesion-modified polyethylenes, and the like; polyesters, including polyethylene terephthalate, polybutylene terephthalate, PCTG, PETG, PCCD, and the like; polyamides such as nylon 6 and nylon 6,6, and the like; polyurethanes, such as pMDI based polyurethanes; and the like; or a combination comprising at least one of the foregoing.

The dual matrix composite or layered structure prepared therefrom can be rolled, folded, or formed into sheets. The composite can be cut or rolled to an intermediate form. The cut dual matrix composite and/or the layered structure can be molded and expanded to form an article of a desired shape, for use in manufacture of further articles. The intermediate rolled, folded, or sheeted dual matrix composite or layered structure can further be molded into an article of a suitable shape, dimension, and structure for use in further manufacturing processes to produce further articles.

While any suitable method of forming an article using the dual matrix composite is contemplated (e.g., thermoforming, profile extrusion, blow molding, injection molding, and the like), in a particular embodiment, the dual matrix composite is advantageously formed into an article by thermoforming, which can reduce the overall cost in manufacturing the article. It is generally noted that the term “thermoforming” is used to describe a method that can comprise the sequential or simultaneous heating and forming of a material onto a mold, wherein the material is originally in the form of a film, sheet, layer, or the like, and can then be formed into a desired shape. Once the desired shape has been obtained, the formed article (e.g., a component of an aircraft interior such as a panel) is cooled below its melt or glass transition temperature. Exemplary thermoforming methods can include, but are not limited to, mechanical forming (e.g., matched tool forming), membrane assisted pressure/vacuum forming, membrane assisted pressure/vacuum forming with a plug assist, and the like. It can be noted the greater the draw ratio the greater the degree of lofting needs to be, to be able to form a useful part, both aesthetically and functionally.

In a particularly advantageous feature, the dual matrix composites and articles formed from the dual matrix composites meet certain flame retardant properties presently required by the airline transportation industry. In an embodiment, the dual matrix composite and articles comprising the dual matrix composite (including a thermoformed sheet and an interior airplane component, and other articles disclosed herein) can exhibit at least one of the following desirable properties: (1) a peak heat release of less than 65 kW/m², as measured by FAR 25.853 (OSU test); (2) a total heat release at 2 minutes of less than or equal to 65 kW*min/m² as measured by FAR 25.853 (OSU test), (3) an NBS (National Board of Standards) optical smoke density of less than 200 when measured at 4 minutes, based on ASTM E-662 (FAR/JAR 25.853). In an embodiment, all three of the foregoing properties are met.

In a specific embodiment, an article includes a thermoformed dual matrix composite, wherein the dual matrix composite includes a network comprising a plurality of reinforcing fibers selected from metal fibers, metallized inorganic fibers, metallized synthetic fibers, glass fibers, graphite fibers, carbon fibers, ceramic fibers, mineral fibers, basalt fibers, polymer fibers having a melt temperature at least 150° C. higher than the polyimide, and combinations thereof; and a matrix comprising (a) melted and cooled polyimide fibers and (b) melted and cooled polymeric binder fibers, wherein the polymeric binder has a melt temperature lower than the polyimide, and wherein the dual matrix composite has a minimum degree of loft of greater than or equal to three and the loft of the dual matrix composite is within 30% over the entirety of the dual matrix composite; and wherein the composite exhibits (1) a time to peak release, as measured by FAR 25.853 (OSU test), (2) a 2 minute total heat release as measured by FAR 25.853 (OSU test), and (3) an NBS optical smoke density of less than 200 when measured at 4 minutes, determined in accordance with ASTM E-662 (FAR/JAR 25.853).

In another embodiment, the combustion products can be nontoxic, that is, the dual matrix composite and articles formed therefrom have toxic emissions levels to pass the requirements for toxicity described in Airbus Test Specifications ATS 1000.0001 and ABD 0031, and Boeing Standard Specification BSS 7239. In an embodiment, the dual matrix composites can have a toxic gases release of less than or equal to 100 ppm based on Draeger Tube Toxicity test (Airbus ABD0031, Boeing BSS 7239). In another embodiment, the dual matrix composites can have, as determined using a Draeger tube, for flaming conditions, less than 150 parts per million (ppm) hydrogen cyanide (HCN), less than 3,500 ppm carbon monoxide (CO), less than 100 ppm nitrogen oxides (NO and NO₂), less than 100 ppm sulfur dioxide (SO₂), and less than 150 ppm hydrogen chloride (HCl); and for non-flaming conditions, less than 150 parts per million (ppm) hydrogen cyanide (HCN), less than 3,500 ppm carbon monoxide (CO), less than 100 ppm nitrogen oxides (NO and NO₂), less than 100 ppm sulfur dioxide (SO₂), and less than 150 ppm hydrogen chloride (HCl).

The dual matrix composites can further have good mechanical properties.

Those skilled in the art will also appreciate that common curing and surface modification processes including but not limited to heat-setting, texturing, embossing, corona treatment, flame treatment, plasma treatment, and vacuum deposition can further be applied to the above articles to alter surface appearances and impart additional functionalities to the articles. Additional fabrication operations can be performed on articles, such as, but not limited to molding, in-mold decoration, baking in a paint oven, lamination, and hard coating.

Articles prepared from these dual matrix composites include those used to fabricate interior panels for aircraft, trains, automobiles, passenger ships, and the like, and are useful where good thermal and sound insulation are desired. Injection-molded parts such as aircraft parts including oxygen mask compartment covers; and thermoformed and non-thermoformed articles prepared from sheets of the dual matrix composites such thermoplastic such as light fixtures; lighting appliances; light covers, cladding or seating for public transportation; cladding or seating for trains, subways, or buses; meter housings; and like applications. Other specific applications include window shades (injection molded or thermoformed), air ducts, compartment and compartment doors for storage, luggage, seat parts, arm rests, tray tables, oxygen mask compartment parts, air ducts, window trim, and other parts such as panels used in the interior of aircraft, trains or ships.

The invention is further illustrated by the following non-limiting examples.

### EXAMPLES

The purpose of these Examples was to evaluate the performance of a thermoformable dual matrix composite made from a combination of (a) a fibrous filler component comprising a plurality of reinforcing fibers, (b) a fibrous polyimide component comprising a plurality of polyimide fibers, and (c) a binder component comprising a plurality of polymeric binder fibers having a melt temperature lower than the polyimide fibers. In some embodiments such composites meet all of the following requirements: (1) a peak heat release of less than 65 kW/m², as measured by FAR 25.853 (OSU test); (2) a total heat release at 2 minutes of less than or equal to 65 kW*min/m² as measured by FAR 25.853 (OSU test), (3) an NBS optical smoke density of less than 200 when measured at 4 minutes, based on ASTM E-662 (FAR/JAR 25.853).

### Materials

The following materials were used in the Examples.

| MATERIAL | DESCRIPTION | SOURCE |
|---|---|---|
| Polyimide | | SABIC |
| fibers | | Innovative |
| | | Plastics |
| LEXAN | Polysiloxane-polyestercarbonate copolymer | SABIC |
| FST fibers | fibers with polysiloxane units having 4-50 | Innovative |
| | siloxane units, and polyestercarbonate units | Plastics |
| | with 50 to 100 mol % of arylate ester units, | |
| | less than 50 mol % aromatic carbonate units, | |
| | less than 30 mol % resorcinol carbonate | |
| | units, and less than 35 mol % bisphenol A | |
| | carbonate units | |
| Glass fibers | | OCF |
| Carrier Layer | lightweight (17 g/m²) glass fabric (106 | BFG |
| | Weave) | |

### Techniques/Procedures

### Procedure for Determining Peak Heat Release and Total Heat Release at Two Minutes, as Measured by FAR 25.853 (OSU Test).

Heat release testing was performed using the Ohio State University (OSU) rate-of-heat release apparatus, by the method listed in FAR 25.853 (d), and in Appendix F, section IV (FAR F25.4). Peak heat release was measured as kW/m² (kilowatts per square meter). Total heat release was measured at the two minute mark in kW-min/m² (kilowatt minutes per square meter). The heat release test method is also described in the “Aircraft Materials Fire Test Handbook” DOT/FAA/AR-00/12, Chapter 5 “Heat Release Test for Cabin Materials.”

### Procedure for Determining the NBS Optical Smoke Density at 4 Minutes, Based on ASTM E-662 (Far/Jar 25.853).

Smoke density testing can be performed according to the method listed in FAR 25.853 (d), and in Appendix F, section V (FAR F25.5). Smoke density was measured under flaming mode. Smoke density at 4.0 minutes was determined.

### Procedure for Draeger Tube Toxicity Testing.

Draeger tube toxicity of gases testing can be performed according to Airbus ABD0031 (also Boeing BSS 7238).

### Procedure for Forming a Thermoformable Dual Matrix Composite.

The dual matrix composite was made according to the following process. The reinforcing fibers, polyimide fibers, and polymeric binder fibers (e.g., polysiloxane-polyestercarbonate copolymer fibers) were mixed in an aqueous slurry to form an aqueous suspension of the fiber mixture. The aqueous suspension was deposited on a wire mesh to form a layer, and water was drained from the layer to form a web.

The web was heated under conditions sufficient to remove any residual water and melt the polysiloxane-polyestercarbonate copolymer fibers to form a matrix that was deposited onto the reinforcing and polyimide fiber surfaces, thereby forming a porous mat.

The porous mat was then consolidated under conditions sufficient to melt the polyimide and compress the mat to form the thermoformable dual matrix composite, such that the polyimide melted onto the reinforcing fiber surfaces and voids were excluded by compression and cooling under pressure to provide low porosity to the finished dual matrix composite sheet.

### Test to Determining Loft of Thermoformable Dual Matrix Composite.

The following test procedure was used for determining degree of loft.
1. A 6 inch strip of the sheet was sheered for sampling and consolidated as described above.
2. Two-inch (50.8 mm) wide samples of the strip were cut once steady state of the consolidation was achieved. The samples were marked with sample number and the thickness was measured.
3. Subsequently the samples were placed in an oven at 400° C. for 5 minutes.
4. After cooling, the thickness of the samples was re-measured and the ratios of the thickness after and before were recorded for each sample as degree of loft.

The degree of loft is a measure of how much the dual matrix composite sheet expands and develops porosity on reheating substantially above the melt temperature of the matrix. Without being bound by theory, it is believed that expansion of the dual matrix composite sheet is due to the reinforcing fibers being bent and trapped during consolidation and cooling. As the sheet is reheated (for example during thermoforming), the reinforcing fibers can straighten as the viscosity of the matrix resin drops with increasing temperature. The extent to which the sheet can expand during heating (loft) is an indication of how well the sheet can be thermoformed. Too high a pressure or too low a temperature during consolidation will cause excessive breakage of the reinforcing fibers, resulting in poor expansion and reduced mechanical properties. Loft does not substantially affect the FST properties of the dual matrix composite.

Procedure for Thermoforming the Dual Matrix Composite into an Article.

The dual matrix composite sheet is cut to the desired size and clamped into a clamp frame in a thermoformer. There it is exposed to heat from an emitter to bring the sheet to the proper forming temperature, e.g., about 365° C. The tool, at a temperature of, e.g., about 175° C., is then closed around the hot sheet. After approximately 1 minute the cooled, formed part can be removed from the tool and prepared for pulling the decorative surface film over the part.

The formed part is prepared for application of a decorative film by trimming the formed part to the final desired dimension. Additional surface treatment such as filling, sanding, and priming can be used, but in an advantageous feature, are not required. The trimmed, formed part is then returned to the vacuum side of the tool (usually the bottom half). A decorative film is placed into the clamp frame and heated to a forming temperature, e.g., 140° C. to 170° C., at which point the film is pulled onto the trimmed part by bringing the trimmed part into contact with the hot film and drawing a vacuum through the lower half of the tool to remove any entrapped air. There is sufficient latent heat in the film to conform to the trimmed, formed part and bond securely to its surface. Upon cooling the part is ready for inspection.

### Examples 1-2 and Comparative Examples 3-8

Dual matrix composites in the form of a consolidated sheet were made in accordance to the procedure above, using the same wt. % of glass fibers, polyimide fibers, and polysiloxane-polyestercarbonate copolymer fibers. Pressure during consolidation and loft are shown in Table 1. The temperature was kept at a constant 365° C. during compression. Thermoformed articles were then made from the dual matrix composites and tested to determine peak heat release, total heat release, and optical smoke density as described above.

TABLE 1

| | | | Consolidated | Lofted | Degree |
|---|---|---|---|---|---|
| | Pressure | Rate** | thickness | thickness | of Loft |
| Ex. No. | Bar | M/min. | Mm | Mm | minimum |
| 1 | 20 | 0.5 | 0.85 | 3.47-3.98 | 4.4 |
| 2 | 30 | 0.5 | 0.85 | 2.7-4.3 | 3.2 |
| 3* | 30 | 0.5 | 0.83 | 2.6-3.3 | 3.2 |
| 4* | 30 | 1.0 | 0.85 | 2.3-3.2 | 2.7 |
| 5* | 35 | 1.5 | 0.83 | 2.5-3.2 | 3.0 |
| 6* | 35 | 1.5 | 0.80 | 2.1-2.9 | 2.6 |
| 7* | 35 | 1.5 | 0.85 | 2.0-2.9 | 2.4 |
| 8* | 35 | 1.5 | 0.85 | 2.2-2.9 | 2.6 |

*Comparative examples
**Rate (meters/minute) at which the mat was introduced into the heated belts during consolidation of the mat.

As can be seen from the results in Table 1, the dual matrix composites of Examples 1 and 2 had a minimum degree of loft greater than or equal to three. The dual matrix composites of Comparative Examples 3-8 were evaluated for loft and it was determined that the minimum degree of loft was less than three, which does not meet the required standards for loft.

Further, thermoformed articles were made from the dual matrix composites and the thermoformed articles exhibited all of the following properties: (1) a peak heat release of less than 65 kW/m², as measured by FAR 25.853 (OSU test); (2) a total heat release at 2 minutes of less than or equal to 65 kW*min/m² as measured by FAR 25.853 (OSU test); and (3) an NBS optical smoke density of less than 200 when measured at 4 minutes, based on ASTM E-662 (FAR/JAR 25.853). Formability and mechanical strength were determined as well, and found to be acceptable.

### Examples 9-13

The purpose of these Examples was to evaluate the uniformity of the lofting features of the thermoformable dual matrix composites. The procedure described above for determining the loft was performed, with the exception that several regions of the board were measured.

The dual matrix composite was made in accordance to the procedure described above, except that:
1. Six inch wide strips were cut from the sheet as it was being produced.
2. Two-inch wide samples of the strip were cut three inches from each edge and from the center, marked with location, measured for thickness, and placed in an oven at 400° C. for 5 minutes.
3. After cooling the samples were re-measured and the ratio of the thickness after and before were recorded for each sample.
   Processing conditions were adjusted to provide similar ratios across the full width of the sheet. The dual matrix composite was tested for its loft properties in accordance to the procedure described above. If the minimum degree of loft was found to be 3 or more and within one sigma above 3, the dual matrix composite was determined to be within the required range.

TABLE 2

| | | | Consolidated | Lofted | Degree |
|---|---|---|---|---|---|
| | Pressure | Rate | Thickness | Thickness | of Loft |
| Ex. No. | Bar | m/min. | Mm | Mm | minimum |
| 9 | 20 | 0.5 | 0.86 | 3.22-3.36 | 3.74 |
| 10 | 20 | 1 | 0.85 | 3.43-3.54 | 4.04 |
| 11 | 10 | 1 | 0.93 | 4.13-4.32 | 4.17 |
| 12 | 10 | 1 | 0.93 | 3.76-4.63 | 4.04 |
| 13 | 10 | 1 | 0.97 | 4.08-4.9 | 4.21 |

The dual matrix composite of Examples 9-13 were evaluated for loft and it was determined that the minimum degree of loft was greater than or equal to three under the conditions used. Thermoformed articles were made from the indicated dual matrix composites and the thermoformed articles each exhibited all of the following properties: (1) a peak heat release of less than 65 kW/m2, as measured by FAR 25.853 (OSU test); (2) a total heat release at 2 minutes of less than or equal to 65 kW*min/m2 as measured by FAR 25.853 (OSU test); and (3) an NBS optical smoke density of less than 200 when measured at 4 minutes, based on ASTM E-662 (FAR/JAR 25.853). The Examples further met the mechanical requirements for strength and stiffness as determined by a third party.

All references are incorporated herein by reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

We claim:

1. A composition for the manufacture of a porous, compressible article, the composition comprising a combination of:
a plurality of reinforcing fibers;
a plurality of polyimide fibers; and
a plurality of polymeric binder fibers;
wherein the polymeric binder fibers have a melting point lower than the polyimide fibers.

2. The composition of claim 1, comprising:
from 30 to 65 wt. % of the reinforcing fibers;
from 30 to 65 wt. % of the polyimide fibers; and
from 2 to 20 wt. % of the polymeric binder fibers, each based on the combined weight of the reinforcing fibers, the polyimide fibers, and the polymeric binder fibers.

3. The composition of claim 1, wherein the plurality of reinforcing fibers comprise metal fibers, metallized inorganic fibers, metallized synthetic fibers, glass fibers, graphite fibers, carbon fibers, ceramic fibers, mineral fibers, basalt fibers, polymer fibers having a melt temperature at least 150° C. higher than the polyimide, or a combination thereof.

4. The composition of claim 1, wherein the reinforcing fibers comprise glass fibers.

5. The composition of claim 1, wherein the polyimide comprises a polyetherimide.

6. The composition of claim 1, wherein the polymeric binder comprises a polysiloxane, polysiloxane-polyestercarbonate copolymer, polyester, polyester-polyetherimide blend, bicomponent fiber of any of the foregoing, or a combination thereof.

7. The composition of claim 6, wherein the polysiloxane-polyestercarbonate copolymer comprises
polysiloxane units comprising from 4 to 50 siloxane units, wherein the siloxane units are present in an amount of 0.2 to 10 wt % of the total weight of the polysiloxane-polyestercarbonate copolymer, and
polyester-polycarbonate units comprising, based on the polyester-polycarbonate units
from 50 to 100 mole percent of arylate ester units,
from more than 0 to less than 50 mole percent aromatic carbonate units,
from more than 0 to less than 30 mole percent resorcinol carbonate units, and
from more than 0 to less than 35 mole percent bisphenol carbonate units; and
wherein the polysiloxane-polyestercarbonate copolymer composition has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853 (d).

8. The composition of claim 7, wherein the arylate ester units are isophthalate-terephthalate-resorcinol ester units.

9. The composition of claim 1, wherein
the average fiber length of the reinforcing fibers is from 5 to 75 millimeters and the average fiber diameter of the reinforcing fibers is from 5 to 125 micrometers;
the average fiber length of the polyimide fibers is from 5 to 75 millimeters, and the average fiber diameter of the polyimide fibers is from 5 to 125 micrometers; and
the average fiber length of the polymeric binder fibers is from 2 millimeters to 5 millimeters, and the average fiber diameter of the polymeric binder fibers is from 5 to 50 micrometers.

10. The composition of claim 1, further comprising an aqueous solvent.

11. A method for forming a porous article, the method comprising:
forming a layer comprising a suspension of the composition of claim 1 in liquid;
at least partially removing the liquid from the suspension to form a web;
heating the web under conditions sufficient to remove any remaining liquid from the web and to melt the polymeric binder fibers but not the polyimide; and
cooling the heated web to form the porous mat, wherein the porous article comprises a network of the reinforcing fibers and the polyimide fibers in a matrix of the polymeric binder.

12. The method of claim 11, wherein forming the web comprises
depositing the composition dispersed in an aqueous suspension onto a forming support element to form the layer; and
evacuating the aqueous solvent to form the web.

13. The method of claim 12, wherein the heating is at a temperature from 130 to 170° C.

14. The method of claim 13, wherein the heating comprises heating in an oven at a temperature from 130 to 150° C., then infrared heating at a temperature from 150 to 170° C.

15. A porous article comprising:
a network of a plurality of reinforcing fibers and a plurality of polyimide fibers; and
a matrix deposited on the network comprising melted and cooled polymeric binder fibers, wherein the polymeric binder has a melt temperature lower than the polyimide fibers.

16. The porous article of claim 15, having an areal weight of from 90 to 500 g/m².

17. A method of forming a dual matrix composite, the method comprising:
heating and compressing at least one of the porous articles of claim 9 disposed on a carrier layer under conditions sufficient to melt the polyimide fibers and consolidate the network;
cooling the heated, compressed article and carrier layer under pressure to form the dual matrix composite comprising
a network comprising a plurality of reinforcing fibers; and
a matrix comprising melted and cooled polyimide fibers and melted and cooled polymeric binder fibers, wherein the polymeric binder has a melt temperature lower than the polyimide.

18. The method of claim 17, comprising heating and compressing a stack comprising two or more of the porous mats.

19. The method of claim 18, comprising heating and compressing a stack comprising two to ten of the porous mats.

20. A dual matrix, thermoformable composite, comprising:
a network comprising a plurality of reinforcing fibers; and
a matrix comprising melted and cooled polyimide fibers and melted and cooled polymeric binder fibers, wherein the polymeric binder has a melt temperature lower than the polyimide, and
wherein the dual matrix composite has a minimum degree of loft of greater than or equal to three.

21. The dual matrix composite of claim 20, wherein the loft of the dual matrix composite is within one sigma, over the entirety of the dual matrix composite.

22. The dual matrix composite of claim 20, wherein the loft of the dual matrix composite is within 30%, over the entirety of the dual matrix composite.

23. The dual matrix composite of claim 20, having a porosity that is less than about 4 volume % of the porosity of the porous article.

24. The dual matrix composite of claim 20, having a melting point of at least 205° C.

25. The dual matrix composition of claim 20, wherein a thermoformed article made from the dual matrix composite has:
a peak heat release of less than 65 kW/m², as measured by FAR 25.853 (OSU test);
a total heat release at 2 minutes of less than or equal to 65 kW*min/m² as measured by FAR 25.853 (OSU test); and
an NBS optical smoke density of less than 200 when measured at 4 minutes, based on ASTM E-662 (FAR/JAR 25.853).

26. The dual matrix composite of claim 20, further having a toxic gases release of less than or equal to 100 ppm based on Draeger Tube Toxicity test (Airbus ABD0031, Boeing BSS 7239).

27. The dual matrix composite of claim 20, wherein the dual matrix composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.

28. The dual matrix composite of claim 20, further comprising a thermal stabilizer, an antioxidant, a light stabilizer, a gamma-irradiation stabilizer, a colorant, an antistatic agent, a lubricant, a mold release agent, or a combination thereof.

29. A method of forming an article, the method comprising:
thermoforming the dual matrix composite of claim 20 to form the article.

30. The method of claim 29, wherein the thermoforming is match metal thermoforming.

31. An article, comprising:
a thermoformed dual matrix composite of claim 20.

32. The article of claim 31, having a porosity from 30 to 75 volume % less than the porosity of the dual matrix composite.

33. The article of claim 32, in the form of an aircraft interior panel.

34. A dual matrix composite, comprising:
a network comprising a plurality of reinforcing fibers selected from metal fibers, metallized inorganic fibers, metallized synthetic fibers, glass fibers, graphite fibers, carbon fibers, ceramic fibers, mineral fibers, basalt fibers, polymer fibers having a melt temperature at least 150° C. higher than the polyimide, and combinations thereof; and
a matrix comprising (a) melted and cooled polyimide fibers and (b) melted and cooled polymeric binder fibers, wherein the polymeric binder has a melt temperature lower than the polyimide, and
wherein the dual matrix composite has a minimum degree of loft of greater than or equal to three and the loft of the dual matrix composite is within 30% over the entirety of the dual matrix composite.

35. An article comprising a thermoformed dual matrix composite of claim 34, wherein the composite exhibits
a time to peak release, as measured by FAR 25.853 (OSU test),
a 2 minute total heat release as measured by FAR 25.853 (OSU test), and
an NBS optical smoke density of less than 200 at 4 minutes, determined in accordance with ASTM E-662 (FAR/JAR 25.853).

36. The article of claim 35, wherein the dual matrix composite does not include a flame retardant, wherein the flame retardant is a perfluoroalkyl sulfonate salt, a fluoropolymer encapsulated vinylaromatic copolymer, potassium diphenylsulfone-3-sulfonate, sodium trichlorobenzenesulfonate, or a combination comprising at least one of the foregoing flame retardants.
